(19) United States
(12) Patent Application Publication
(10) Pub. No.: US 2016/0039022 A1
(43) Pub. Date: Feb. 11, 2016

(54) System For Adjusting The Cut Thickness Of A Band Saw

(71) Applicant: Douglas Carden, Barneveld, WI (US)

(72) Inventor: Douglas Carden, Barneveld, WI (US)

(21) Appl. No.: 14/818,634

(22) Filed: Aug. 5, 2015

Related U.S. Application Data
(60) Provisional application No. 62/034,291, filed on Aug. 7, 2014.

(51) Int. Cl. B23D 59/00; B27B 15/02; B27B 29/08

(52) U.S. Cl. CPC B23D 59/002; B27B 29/08; B27B 15/02

(57) ABSTRACT

A system for positioning the cutting edge of a band saw blade at a desired vertical height with respect to a log. The system includes a frame bed for retaining a log in a fixed position. A powered horizontal trolley moves the band saw along a generally horizontal path to cut a board from a log and a powered vertical trolley moves the cutting edge of the saw blade vertically. A sensing arm pivotally on the vertical trolley has a distal end that rides along the log during the cutting process. The system senses the position of the sensing arm as it rises to control the position of the vertical trolley. An adjustment system allows the user to set the depth of cut of the cutting edge of the saw blade.

### REFERENCE TO RELATED APPLICATIONS

This application is based upon and hereby claims priority to Provisional Patent Application Ser. No. 62/034,291, tiled Aug. 7, 2014 and entitled “System For Adjusting The Cut Thickness Of A Band Saw” and the specification of that provisional patent application is hereby incorporated herein in its entirety by reference.

### BACKGROUND OF THE INVENTION

The present invention relates to a band saw for cutting a log into boards and, more particularly, to a system for automatically and consistently setting the cutting edge of the band saw blade to make as cut of the log at a predetermined thickness.

There, are various types of saws that are in use today that are used to cut logs into usable boards. One typical type us the hand saw mill which has an endless steel band saw blade affixed to the mill so as to have a horizontal cutting edge that is set to cut the log. Typically, the log remains stationary on a steel frame bed. The hand saw moves along a track affixed to the steel bed on a horizontal plane so that the cutting edge of the band saw passes through the log at a predetermined vertical position to cut a board of a predetermined thickness.

While effective to cut a log into boards, it is important to have the vertical height of the cutting edge of the blade set at an accurate height with respect to the log so that the resulting board is cut having accurate and repeatable thickness. At the present, the user's judgment comes into play with the use of a yardstick type measuring device with a pointer moving along the yardstick to establish the depth of the saw cut along a log. As such, it is necessary to have a system that accurately and automatically can set the vertical height of the saw blade to provide a consistent and accurate thickness and without relying on the judgment of the operator of the band saw mill.

It would be, therefore, advantageous to have a system that can automatically and consistently set the vertical height of the cutting edge of a band saw blade with respect to the log being cut so that the resulting board is produced repeatedly at the desired thickness.

### SUMMARY OF THE INVENTION

The present invention provides a simple, mechanical system to accurately and automatically establish the depth of cut of a saw blade through a log.

These and other features and advantages of the present invention will become more readily apparent during the following detailed description taken in conjunction with the drawings herein.

### BRIEF DESCRIPTION OF THE DRAWINGS

FIG. 1 is a schematic view of the system of the present invention;

FIG. 2 is a side view of a control box used with the present invention;

FIG. 3 is an outside view of an adjustment system used with the present invention;

FIG. 4 is an inside view of the adjustment system of FIGS. 3; and

FIG. 5 is an exploded view of a trip pin assembly used with the present invention.

### DETAILED DESCRIPTION OF THE INVENTION

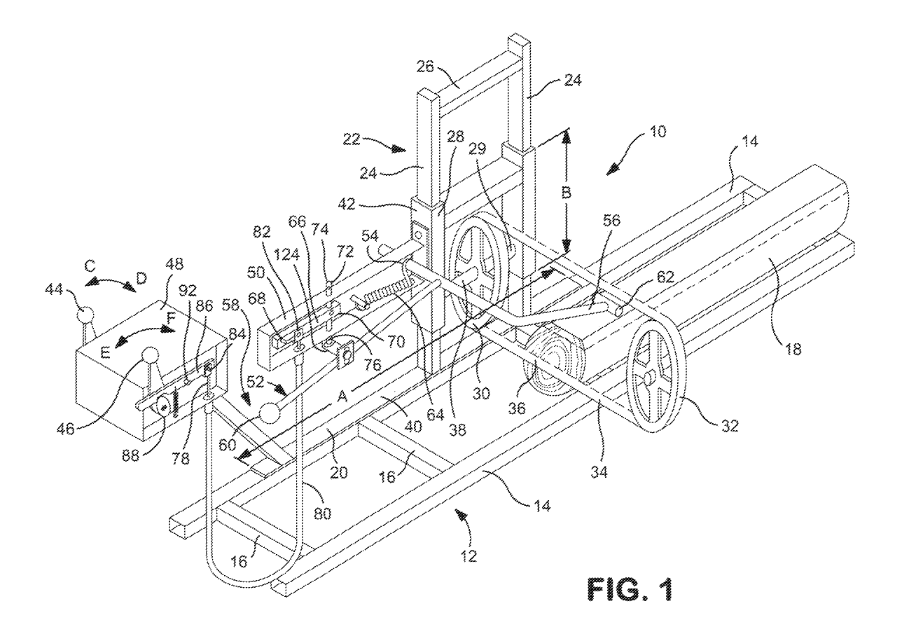

Referring now to FIGS. 1, there is shown a schematic view of a band saw 10 that has the system of the present invention incorporated therein. As a preface, the present invention can be manufactured along with a band saw or, alternatively, it can be retrofitted to existing band saws so that the advantages of the present invention can be enjoyed by current users of commercial band saws.

To that end, the present invention will be explained as a part of a specific commercially available band saw, however, it will be noted that the present invention is applicable to being built into any commercial hand saw by the original equipment manufacture or applied to other equipment. It will be seen that the invention is, in this description, applied to a band saw where the log is held stationary and the hand saw moves along the log, however, it can be appreciated that the present invention could also be use where the hand saw is stationary and the log is moved horizontally past the saw blade,

As such, and as shown in FIG. 1, the band saw 10 includes a frame bed 12 that is generally constructed of steel and which is comprised of two elongated side members 14 and cross members 16. The frame bed 12 forms the foundation of the band saw 10 and a log 18 is shown on the frame bed 12 in position for being cut into boards. The log 18 is affixed firmly to the frame bed 12 by conventional means such that the log 18 is immovable during the cutting process with respect to the frame bed 12.

As a further component of the band saw 10 there is a horizontal trolley 20 that is movably mounted to one of the elongated side members 14 and moves along a horizontal path shown by the arrow A in a manner and for a purpose that will be explained. A vertical frame 22 extends upwardly from the horizontal trolley 20 and is comprised of vertical frame side members 24 and a vertical frame cross member 26. A vertical trolley 28 is movably affixed to the vertical frame 22 such that the vertical trolley 28 can be moved along a vertical path shown by the arrow B while stabilized by the vertical frame 22.

An axle 29 is located on the vertical trolley 28 and which supports a rotating drive wheel 30. An outer wheel 32 is located generally in alignment with the drive wheel 30 and is located on the opposite side of the frame bed 12 such that a saw blade 34 can partially encircle both the drive wheel 30 and the outer wheel 32 and be retained therein by tension. Typically, the outer wheel 32 is held in its position, as shown, by a cantilever beam or beams that extend outwardly from the vertical trolley 28.

The saw blade 34 has a cutting edge 36 that faces the log 18 in order to cut the log 18 into boards. In reality, of course, there are teeth on the saw blade 34 along its entire length; however, for purposes of explaining the present invention, the cutting edge 36 is defined as that locale of the saw blade 34 that contacts and carries out the actual cutting of the log 18 into boards.

The drive wheel 30 is rotated by a drive wheel power source 38 that is conventional and may comprise a electric motor, gas or diesel engine, associated gearing and a drive chain, belt or other conventional means to rotate the drive wheel 30. In a similar fashion, there is a horizontal trolley power source 40 that provides the power to move the horizontal trolley 20 along its horizontal path in both directions as well as a vertical trolley power source 42 that moves the vertical trolley 28 along its vertical path. Both the horizontal trolley power source 40 and the vertical trolley power source 42 can be conventional power sources including electric motors, speed reducers and chain drives as needed.

There are also controls by which the user can control the horizontal trolley power source 40 and the vertical trolley power source 42 and those controls are shown as horizontal control lever 44 and vertical control lever 46. As illustrated b the arrow C-D, as the horizontal control lever 44 is moved toward D of the arrow, horizontal trolley 20 carrying the cutting edge 36 of the saw blade 34 is moved in the direction toward the log 18, that is, to the right as shown in FIG. 1, and when the horizontal control lever 44 is moved toward C of the arrow, the horizontal trolley 20 and saw blade 34 are moved in the direction away from the log 18, that is, to the left in FIG. 1.

The vertical control lever 46 operates in a similar manner and, using the arrow E-F, as the vertical control lever 46 is moved toward F of the arrow the vertical trolley 28 is moved upwardly and when the vertical control lever 46 is moved toward E of the arrow, the vertical trolley 28 is moved downwardly in its vertical path.

As also can be seen, both the horizontal control lever 44 and the vertical control lever 46 are mounted on a control. box 48 that is, in turn, affixed to the horizontal trolley 20 and moves therewith.

To this point, the description has basically outlined a standard band saw as can be obtained commercially. The present invention, as previously mentioned, can be retrofitted to an existing band saw as an accessory or can be installed along with a commercial band saw b the original equipment manufacturer.

A housing 50 is provided and which contains certain of the components of the present invention. The housing 50 is affixed to the vertical trolley 28 and therefore moves therewith. There is a sensing arm 52 that is pivotally affixed to the housing 50 at pivot point 54 that may be a bearing or some other means of allowing the sensing arm 52 to pivot freely about the pivot point 54.

The sensing arm 52 has a distal end 56 that contacts the upper surface of the log 18 and a proximal end 58 that has an enlarged end such as a ball 60 to be readily handled and manipulated by the user. The distal end 36 has a cylindrical member 62 that assures that part of the distal end 56 of the sensing are 52 always rests on the previously sawn surface of the log 18 during the automatic blade setting for the desired board thickness. A spring 64 is located within the housing 50 and is attached to the sensing arm 52 to provide a spring bias that biases the distal end 56 of the sensing arm 52 downwardly and firmly against the log 18.

A trip lever 66 is also located within the housing 50 and is rotatable about pivot point 68 leaving its free end 70 to move about the pivot point 68. Affixed to the trip lever 66 proximate to the free end 70 is a trip rod 72 and, as can be seen, the trip rod 72 has an upper end 74 and a lower end 76 that both extend outwardly from the housing 50 so that the corresponding openings in the housing 50 through which the trip rod 72 extends retains the trip rod 72 for vertical movement with respect to the housing 50.

A wire 78 of a shielded cable 80 is provided with one end 82 affixed to the trip lever 66 at a point intermediate the pivot point 68 and the free end 70 of the trip lever 66. The other end 84 of the wire 78 is affixed to a control box lever 86 that is on the control box 48.

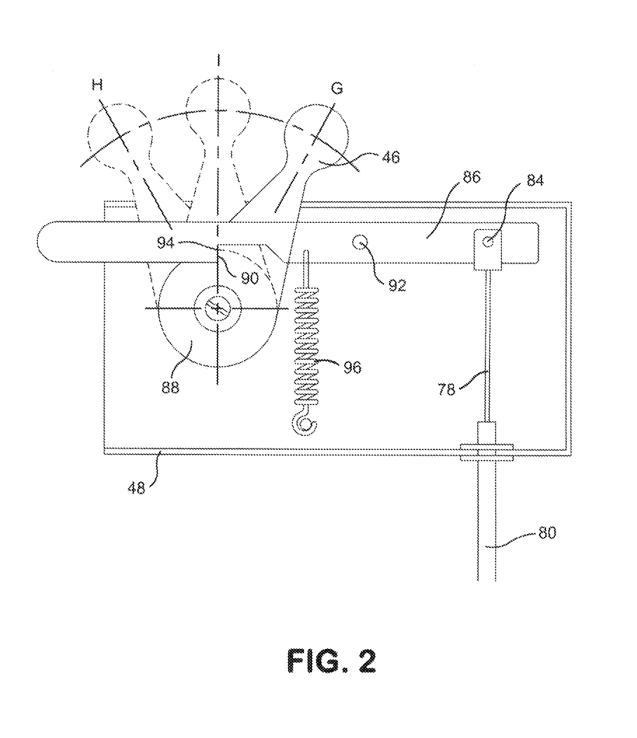

Turning then to FIG. 2, taken along with FIG. 1, there is a side view illustrating a more detailed view of the control box 48 in order to explain the purpose of the wire 78. As can be seen, the vertical control lever 46 is movable between the position shown at G where the vertical control lever 46 is in the forward position and the vertical trolley 28 is caused to move in the upward direction. In position H or the rearward position of the vertical control lever 46, the vertical trolley 28 is caused to move in the downward direction and in position 1, the neutral position, the vertical trolley 28 is in the stopped position. Both the vertical control lever 46 and the horizontal control lever 44 are spring biased to return to the neutral position when released b the operator.

The control system of the present invention includes a trip block 88 that is mounted so as to move with the. vertical control lever 46 and can be easily uninstalled on existing systems. The trip block 88 has a notch 90 formed therein for a purpose that will be later explained. As an alternative, the features of the trip block 88 may be incorporated directly into the vertical control lever 46 such as when the invention is constructed by an original equipment manufacturer.

As can be seen, the control box lever 86 is pivotally affixed to the control box 48 at a pivot point 92 also has a notch 94. A spring 96 biases the portion of the control box lever 86 having the notch 94 in the downward direction so as to engage the corresponding notch 90 of the trip block 88. As such, when the vertical control lever 46 has been moved to its forward position, that is, the solid line position G, the control box lever 84 drops down, by the bias of spring 96, about pivot point 92 and into the notch 90 of the trip block 88 se as to prevent the vertical control lever 46 from returning to its neutral position. Accordingly, the vertical control lever 86 locks the vertical control lever 46 in its forward position, that is, where the vertical trolley 20 is rising upwardly.

As also can be seen, the downward movement of the wire 78 will cause the notch 94 of the control box lever 86 to move upwardly so as to release the interconnection with the trip block 88 and allow the vertical control lever 46 to return to its neutral position where movement of the vertical trolley 23 ceases.

There is also an adjustment thickness system than allows the user to accurately and automatically set the vertical height of the caning edge 36 of the saw blade 34 in order to establish the thickness of a board being cut from the log 18.

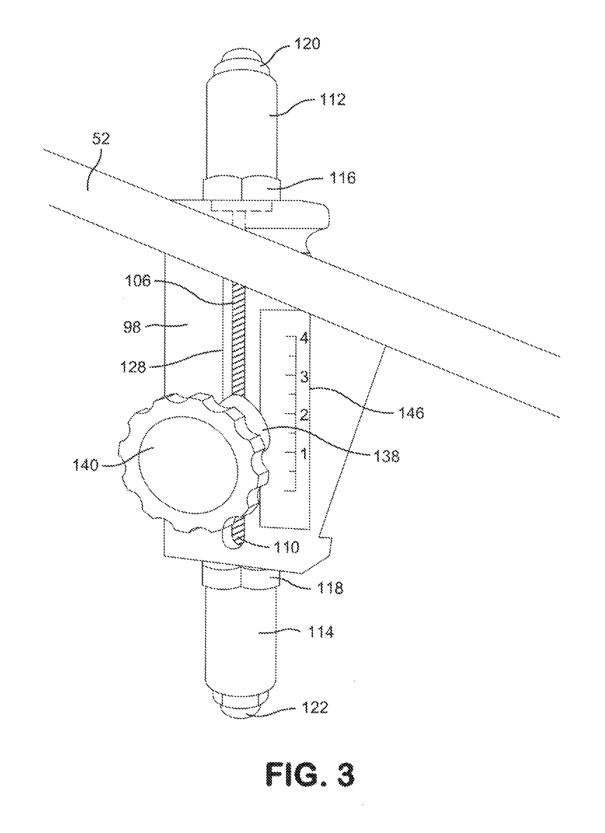

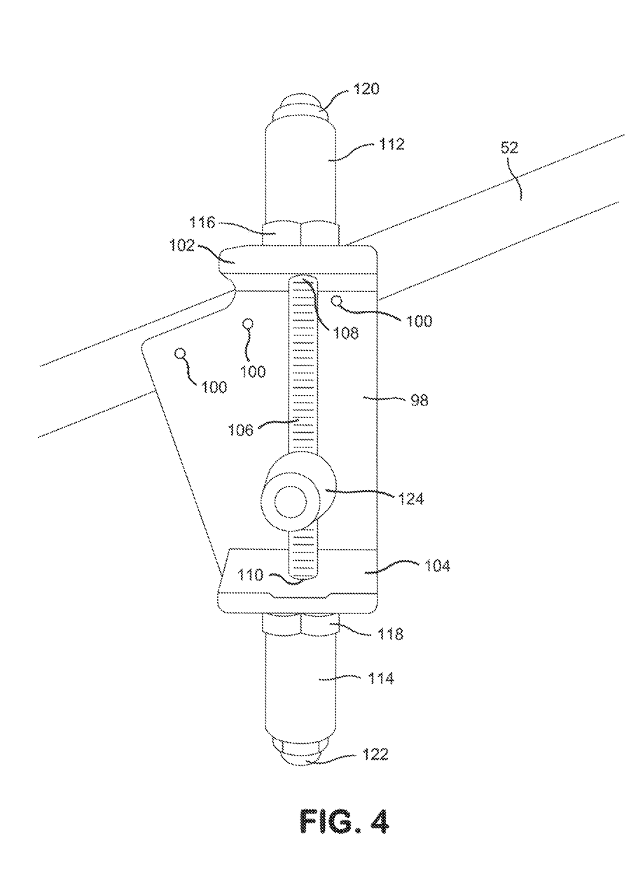

Turning then to FIGS. 3 and 4, taken along with FIG. 1, there is shown an outside view and an inside view, respectively, of the adjustment system and which comprises a trip pin body 98 that is affixed to sensing arm 52. That affixation may be by means of machine screws 100, welding or other means to carry out that affixation. A set of generally horizontal flanges 102, 104 are formed in the trip pin body 96 and a threaded rod 106 passes through openings 108, 110 in each of the horizontal flanges 102, 104 so that the threaded rod 106 can move freely in the openings 108, 110.

A pair of adjusting knobs 112, 114 are provided on each end of the threaded rod 106. The adjusting knobs 112, 114 are both internally threaded so as to be threadedly engaged to the threaded rod 106. Bushings 116, 118 are also threaded on to the. threaded rod 106 and acorn nuts 120, 122 are threaded on to the ends of the threaded rod 106. As such, by the tightening of the acorn nuts 120, 122, the adjusting knobs 112, 114 are secured to the threaded rod 106 such that rotation of either or both of the adjusting knobs 112, 114 causes the threaded rod 106 to also rotate.

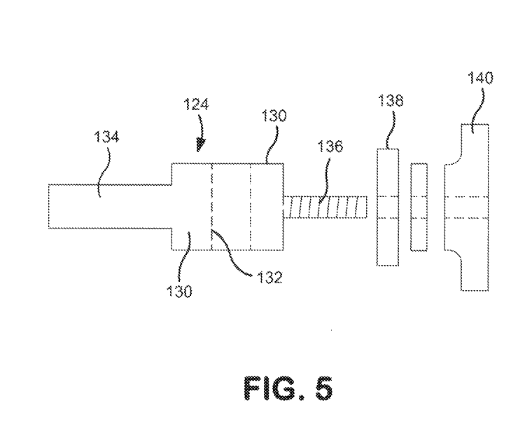

A trip pin 124 is movably affixed to the trip pin body 98 along to slot 128 formed in the trip pin body 98. Turning briefly to FIG. 5, taken along with FIGS. 14, there is shown an exploded view of the assembly of the. trip pin 124 so as to illustrate how it is affixed to the trip pin body 98. As such, the trip pin 124 is shown and which has a main body 130 with a threaded opening 132. therethrough and which corresponds to the threads of the threaded rod 106. The trip pin 124 also has an elongated extension 134 at one end thereof and a threaded screw 136 extending outwardly from the other end. A pointer 138 is affixed to the threaded screw 136 and a locking knob 140 having a threaded opening 142 is secured to the threaded screw 136 with a plastic washer 144 intermediate the locking knob 140 and the pointer 138.

A scale 146 is provided on the trip pin body 98 and can be graduated in measures of 1-4 inches or, in the alternative, in dimensions in the metric system. As can therefore be seen, the pointer 138 points to the scale 146 and, in particular, to the specific dimension desired by the user. In the use of the thickness adjustment system, the vertical location of the trip pin 124 can be set with respect to the sensing arm 52 by loosening the locking knob 140 and then turning either of the adjusting knobs 112, 114 so that the threaded rod 106 rotates and moves the trip pin 124 vertically. When the user has then made the adjustment, the pointer 138 is pointed to the desired number, indicative of thickness; the user discontinues the vertical movement of the trip pin 124 and tightens the locking knob 140 so as to firmly set the pointer 136 as well and the vertical position of the trip pin 124 at the desired location.

Returning briefly to FIG. 1, it can be seen that the trip pin 124 is aligned with and is oriented directly underneath the trip rod 72 such that upward vertical movement of the trip pin 124 will eventually cause the trip rod 72 to move upwardly.

Accordingly, it is now possible to fully describe the use and operation of the system for positioning the cutting edge 36 of a band saw blade to cut a predetermined thickness of a board from the log 18 with reference to FIGS. 1-5.

Initially, the user can manipulate the ball 60 located at the proximal end 58 of the sensing arm 52 so that the cylindrical member 62 at the distal end 56 of the sensing arm 52 is not resting on the log 18. The user can then use the vertical control arm 46 to lower the cutting, edge 36 of the saw blade 34 to an eyeball vertical position and use the horizontal control lever 44 to make an initial cut of the log 18.

As this point, the upper surface of the log 18 is smooth and the distal end 56 of the sensing arm 52 can be oriented atop of the smooth surface of the log 18 by the user manipulating the b all 60 at the proximal end 58 of the sensing arm 52.

Once the cylindrical member 62 is resting on the log 18, the user lowers the cutting edge 36 by lowering the vertical trolley 28 through use of the vertical control lever 46 to another eyeball vertical location that is obviously underneath the thickness of the desired board to be cut. The user then moves the vertical control lever 46 to the forward position, indicated as F on FIG. 1 and, as explained, that movement locks the vertical control lever 46 into the position F since the control bar lever 86 drops into the notch 90 formed in the trip block 88. The vertical control lever 46 is thus locked into position while the vertical trolley 28 rises along with the cutting edge 36 of the saw blade 34.

Since the pivot point 54 of the sensing arm 52. is carried by the now rising vertical trolley 28 and the distal end 56 remains stationary atop of the log 18, the proximal end 58 of the sensing arm 52 rises and eventually the trip pin 124 will contact and cause the trip rod 72 to move vertically upwardly. The upward movement of the trip rod 72 will contact and lift the opposite end of the control bar lever 86, since it is pivoted at pivot point 68, and cause the one end 82 of the wire 78 to move vertically upwardly.

That motion, transmitted through the wire 78, then causes the other end 84 of the wire 78 to move downwardly until it pivots the control bar lever 86 at point 92 to move the opposite end of the control bar lever 86, control bar lever 86 to move upwardly until it moves the control bar lever 86 out of the notch 90 in the trip block 88 to release the vertical control lever 46 from its locked position so that it returns to its .spring-biased neutral position, 1 of FIG. 2 and stops the upward movement of the vertical trolley 28. At this point, the cutting edge 36 of the saw blade 34 is properly positioned vertically with respect to the log 18 so that the cut can be made with the preset thickness desired by the user.

An adjustment system is used to determine the thickness of that cut. As noted in FIGS. 3 and 4, the relative distance between the trip pm 124 and the sensing aria 52 can be changed by the user by merely moving the trip pin 124 up or down vertically with respect to the sensing arm 52. Manually adjusting the trip pin 124 controls the vertical movement of the sensing arm 52 and resulting contact and movement of the trip rod 72. As such, the user can adjust the location of the trip pin 124, as desired, to select the particular thickness of the cut by setting the pointer 138 at the thickness indicated on the scale 146.

Accordingly, it can be seen that the present system allows a user to automatically and reliably set the cutting edge 36 of a saw blade 34 at a desired height by simply setting that desired height on a scale 146 and thereafter the system will automatically and reliably carry out the setting of the blade height to tallow the desires of the user.

The process can be used repetitively, that is, the user can manipulate the ball 60 to move the distal end 56 of the sensing arm 52 such that the distal end 56 always rests on a previously sawn surface. In that way, the distal end 56 can sense the previously sawn surface to properly and accurately reference the distance back to the trip pin 124 and stop the vertical trolley 28 at the correct position to result in the preset board thickness.

Once the vertical trolley 28 stops its vertical upward travel, the trip pin 124 and the linkage back to the trip block 88 on the control bar lever 87, the sending arm 52 can be rotated up off of the log by the user by manipulating the ball The sensing arm 52 will them be held up in that detent position until the cut is made and the horizontal trolley 2 returns the band saw 10 to the thee of the log 18, at which time, the vertical trolley 28 is lowered again to sense the newly cut surface and the process to reset the cutting edge 36 of the saw blade 34 is repeated.

Those skilled in the art will readily recognize numerous adaptations and modifications which can be made to the log cutting system which will result in an improved system and method yet all of which will tall within the scope and spirit of the present invention as defined in the following claims. Accordingly, the invention is to be limited only by the following claims and their equivalents.

What is claimed is:

1. A system for positioning the cutting edge of a band saw blade at a desired vertical height with respect to a log, the system comprising a frame bed adapted to retain a log in a fixed position, a powered horizontal trolley adapted to move the band saw along a generally horizontal path to cut a board from a log, a powered vertical trolley, a band saw blade rotatably affixed to the vertical trolley, the hand saw blade having a cutting edge facing the log, a sensing arm pivotally mounted at a fixed pivot point with respect to the vertical carriage, the sensing arm having a distal end adapted to rest on an upper, previously sawn surface of a log, the system adapted to sense the position of the distal end of the sensing arm resting on the previously sawn surface of the log to control the vertical trolley to establish the vertical position of the cutting edge of the saw blade.

2. The system of claim 1 further including a vertical control lever to control the powered vertical trolley, the vertical control lever having a forward position to move the vertical trolley upwardly, a rearward position to move the vertical trolley downwardly and a neutral position, the vertical control lever being biased toward the neutral position and a control box lever adapt to lock the vertical lever in the forward position.

3. The system of claim 2 further including a trip lever that can be activated when the vertical trolley rises to a desired vertical height and the trip lever moves the control box lever to release the lock of the vertical lever to a low the vertical lever to mover to the neutral position to cease movement of the vertical trolley.

4. The system of claim 1 wherein the system includes a trip lever activated by upward movement of the vertical trolley, wherein the upward movement of the vertical trolley causes a trip lever to move to detach the locked vertical lever arm.

5. The system of claim 1 wherein the sensing arm has a proximal end and is pivotally mounted to the vertical trolley at a pivot point intermediate the distal end and the proximal end, wherein as the vertical trolley is moved upwardly, the distal end of the sensing ant descends and the proximal arm ascends, wherein the proximal end of the sensing arm eon acts and moves the trip lever to detach the locked vertical control lever arm.

6. The system of claim 1 wherein a wire is connected between the trip lever and the control box lever to transmit motion of the trip lever to the control box lever detach the locked vertical control lever arm.
